(19) United States
(12) Patent Application Publication
(10) Pub. No.: US 2023/0021519 A1
(43) Pub. Date: Jan. 26, 2023

(54) Atmospheric Water Harvester with Cryogenic System

(71) Applicant: The Tisdale Group, LLC, Lebanon, TN (US)

(72) Inventors: Donald Wade BARKER, Lebanon, TN (US); Matthew BALDWIN, Antioch, TN (US); Gregory Wyatt Mabry, Chattanooga, TN (US)

(21) Appl. No.: 17/485,991

(22) Filed: Sep. 27, 2021

Related U.S. Application Data
(60) Provisional application No. 63/225,227, filed on Jul. 23, 2021.

(51) Int. Cl. E03B 3/28; B01D 53/26

(52) U.S. Cl. CPC E03B 3/28; B01D 53/265

(57) ABSTRACT

An atmospheric water harvesting system includes a water-harvesting unit with an air mover and a heat exchanger. The water-harvesting unit may also include one or more screens on which water can condense. The water-harvesting unit is supplied by a coolant pathway, in which a non-cryogenic fluid coolant flows. A cryogenic cell is in the coolant pathway. The cryogenic cell receives the fluid coolant and removes heat from it by causing or allowing a controlled heat transfer between the fluid coolant and a first cryogen sealed within an inner vessel in the cryogenic cell. The coolant may be a liquid at operating temperatures, and the cryogenic cell may cool it to an appropriate temperature without a phase change, essentially acting as a “cold battery” to remove heat from the coolant.

### TECHNICAL FIELD

The invention relates to atmospheric water harvesting systems.

### BACKGROUND

Atmospheric water harvesters are devices that extract water from ambient air. Most commercial devices of this type use a conventional compression/expansion refrigeration cycle with a chlorofluorocarbon, hydrofluorocarbon, or other such conventional refrigerant to cool ambient air to a temperature below the dew point, so that water condenses out of the air.

These types of devices have several disadvantages. First, the range of temperatures that can be achieved with conventional refrigeration cycles is limited, meaning that there may be some conditions of ambient temperature and humidity in which a conventional atmospheric water harvester may be unable to extract water or, at least, unable to do so efficiently. Even when an atmospheric water harvester can reach a temperature sufficient to cause water to condense, it may consume a lot of energy in doing so. Finally, atmospheric water harvesters are often deployed where infrastructure is limited; however, servicing and repairing these devices may require specialized parts and service that are not readily available where they are deployed.

### SUMMARY OF THE INVENTION

One aspect of the invention relates to an atmospheric water harvesting system. The system includes a water-harvesting unit with an air mover and a heat exchanger. The water-harvesting unit may also include one or more screens on which water can condense. The water-harvesting unit is supplied by a coolant pathway, in which a non-cryogenic fluid coolant flows. A cryogenic cell is in the coolant pathway. The cryogenic cell receives the fluid coolant and removes heat from it by causing or allowing a controlled heat transfer between the fluid coolant and a first cryogen sealed within an inner vessel in the cryogenic cell.

The coolant may be a liquid at operating temperatures, and the cryogenic cell may cool it to an appropriate temperature without a phase change, essentially acting as a “cold battery” to remove heat from the coolant. Because the cold source is cryogenic in nature, the system can operate in a variety of ambient conditions, reaching even very low dew points to cause water to condense. If ice formation on the heat exchanger or the condensing screens is a possibility in particular ambient conditions, a de-icing system, such as a system of resistance heating wires, may be provided and used to dislodge the ice. In some embodiments, a controller that includes a weather station may be included, allowing the system to adapt coolant temperatures and other operating characteristics as necessary to meet ambient conditions, including the dew point.

Systems according to embodiments of the invention may be designed to allow the user-serviceable components, such as the heat exchanger and air mover, to be easily removed and replaced. In some embodiments, the heat exchanger and air mover may be a combined unit, such as an off-the-shelf oil cooler typically used in automotive applications.

Other aspects, features, and advantages of the invention will be set forth in the description that follows.

### BRIEF DESCRIPTION OF THE DRAWING FIGURES

The invention will be described with respect to the following drawing figures, in which like numerals represent like features throughout the drawing figures, and in which:

FIG. 1 is a schematic illustration of a system according to one embodiment of the invention;

FIG. 2 is a partially sectional perspective view of the cryogenic cell of the system of FIG. 1;

FIG. 3 is a perspective view of a water-harvesting unit of the system of FIG. 1, shown without its outer panels;

FIG. 4 is a cross-sectional view taken through Line 4-4 of FIG. 3;

FIG. 5 is a schematic illustration of a system according to another embodiment of the invention; and

FIG. 6 is a schematic illustration of a system according to yet another embodiment of the invention.

### DETAILED DESCRIPTION

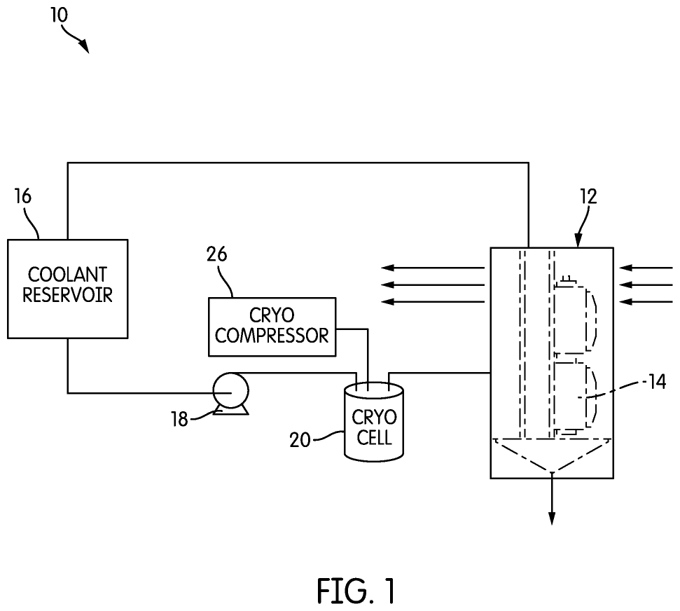

FIG. 1 is a schematic illustration of an atmospheric water harvesting system, generally indicated at 10, according to one embodiment of the invention. In system 10, a water-harvesting unit 12 draws in ambient air and uses a heat exchanger 14 to cool the air to a temperature below the dew point, causing water to condense out of the air. The heat exchanger 14 within the water-harvesting unit 12 is supplied with a circulating coolant that is pumped and circulated from a reservoir 16 by a circulating pump 18. Between the reservoir 16 and the inlet to the heat exchanger 14, the coolant flows through, and is cooled by, a cryogenic cell 20.

In system 10, the coolant is a fluid, and is preferably a liquid at operating temperatures. Here, the phrase “operating temperatures” refers to the range of temperatures necessary to cool air below the ambient dew point and thus cause condensation. In particularly arid or cold environments, this may mean that the coolant reaches a temperature below 0° F. (−18° C.). If a liquid is used, any liquid having appropriate physical properties (e.g., freezing point, specific heat capacity) may be used as the coolant. This may include glycols, like ethylene glycol and propylene glycol; mixtures of water and glycols; alcohols, like methanol, ethanol, n-propanol, and isopropanol; alcohol-water mixtures; ammonia and ammonia-water mixtures; and oils, such as conventional motor oil and other long-chain hydrocarbons. Of the potential range of liquid coolants that may be used, preference would typically be given to coolant liquids that are readily available, nontoxic, non-flammable, and of limited reactivity. For example, propylene glycol and glycol/water mixtures may be particularly suitable, but in some installations, motor oils may be used instead if they are readily available.

Notably, in the circuit illustrated in FIG. 1, the coolant does not undergo a phase change at any point; it merely circulates between the water-harvesting unit 12 and the reservoir 16, and it is cooled by the cryogenic cell 20. Thus, other than ensuring that the coolant will not freeze at operating temperatures, the physical properties of the coolant are less important than in refrigerant-based systems that use phase changes to achieve their desired effects. For the same reasons, the coolant in system 10 is not a conventional fluorocarbon refrigerant.

Although a coolant reservoir 16 is shown as a part of system 10 in FIG. 1, the reservoir 16 is an optional component. In some embodiments, the coolant pathway may contain sufficient coolant without the need for a dedicated reservoir 16. In that case, coolant may simply be added to an input or charging port at some point in the coolant pathway.

In system 10, the cryogenic cell 20 essentially acts as a cold source or cold “battery” that serves to remove heat from the circulating coolant and to bring it to operating temperatures without changing its phase. Although the cryogenic cell 20 is referred to as such because of the way in which it operates, the circulating coolant itself is not a cryogen and is not lowered to cryogenic temperatures. (International authorities define “cryogenic temperature” as being below 120° K (−153° C./−243° F.).) The basic details of a cryogenic cell are disclosed in U.S. Provisional Patent Application No. 63/225,227, filed Jul. 23, 2021, the contents of which are incorporated by reference herein in their entirety.

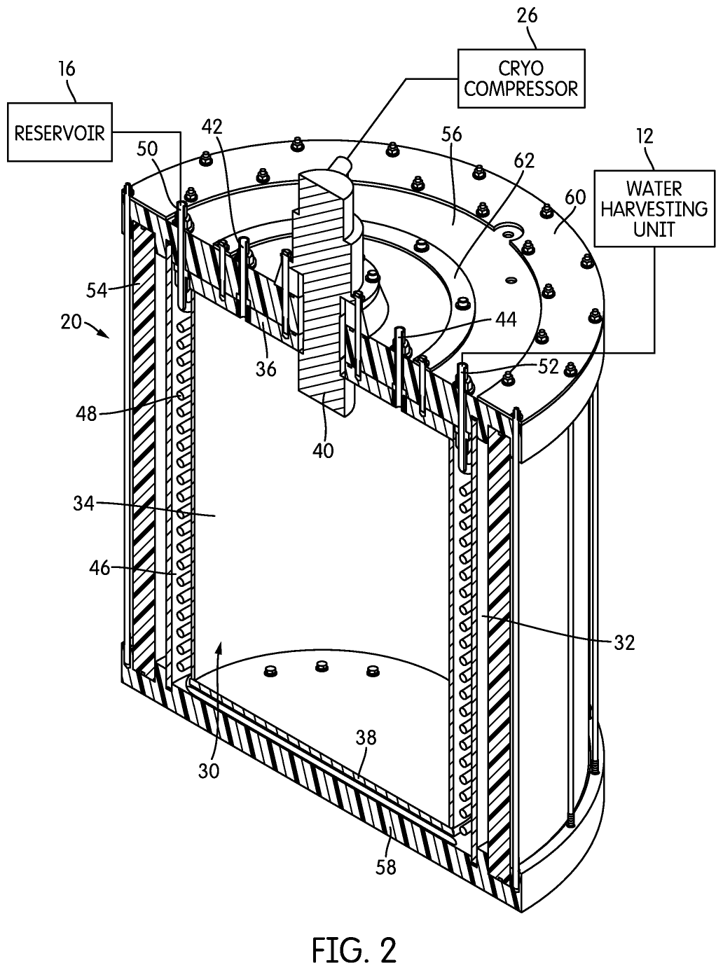

FIG. 2 is a partially sectional perspective view of the cryogenic cell 20, illustrating its structure. The cryogenic cell 20 has an inner vessel 30 and an outer vessel or shroud 32. In the illustrated embodiment, the inner vessel 30 has a tubular sidewall 34, a circular top 36, and a circular bottom 38, although other shapes are possible.

The components 34, 36, 38 of the inner vessel 30 are made such that the inner vessel 30 is capable of containing the working pressures of a cryogen held within. It is helpful if the walls of the inner vessel 30 also have some degree of thermal conductivity. For these reasons, the components of the inner vessel 30 may be made of a metal, such as aluminum, copper, or stainless steel. For example, 6061 T6 aluminum may be used for its relatively high thermal conductivity and sufficient rigidity. The inner vessel 30 may be designed to operate at pressures of up to, e.g., 400 psi, and the thicknesses of the components 34, 36, 38 may be selected appropriately by taking the operating pressure into consideration.

A first cryogen is held within the inner vessel 30. Typically, that first cryogen would be liquid nitrogen, although other cryogens may be used. The first cryogen is kept in liquid phase by a cold head 40 supplied with a second cryogen that is colder than the first cryogen. The second cryogen may, e.g., be liquid helium, although liquid hydrogen, liquid argon, and other, more exotic cryogens may also be used. Because of the cold head 40, any of the first cryogen that heats or expands into gas phase is caused to condense back into liquid phase. The cold head 40 is connected to a self-contained compressor 26 (shown in FIG. 1) that compresses the second cryogen back into liquid form after it is heated. An input port 42 is provided in the inner vessel 30 that allows it to be filled with the first cryogen. An output port 44 is also provided. In some cases, the output port 44 may be used as a drain; however, it would typically be equipped with a pressure relief valve set to release pressure within the inner vessel 30 if the pressure grows beyond a defined threshold, e.g., 300-400 psi.

While the cold head 40 keeps the first cryogen in liquid state, as will be described below, there is heat transfer into the inner vessel 30. For that reason, the cold head 40 may actually drive the first cryogen to a lower temperature than required to keep it in liquid form.

The outer vessel or shroud 32 surrounds the sidewall 34 of the inner vessel 30, creating a space 46 between the sidewall 34 of the inner vessel 30 and the shroud 32. The shroud 32 is a structural component, capable of containing pressure. For example, the shroud 32 may also be made of a metal, such as aluminum. In the space 46 between the inner vessel 30 and the shroud 32, a set of tubes or coils 48 are provided. The coils 48 are positioned in the middle of the space 46; they do not directly contact the outer surface of the sidewall 34 in this embodiment.

In U.S. Patent Application Publication No. 2019/0226745, the comparable space between the walls of a double-walled vessel is filled with an aerogel. By contrast, the space 46 is devoid of an insulator. Instead, in order to vary the heat transfer between the inner vessel 30 and the coils 48, a compressible fluid is pumped into the space 46. The compressible fluid may be, e.g., air, nitrogen, or some other gas. If very little heat transfer is required, the space 46 may be pumped down to a vacuum or near-vacuum. For example, pressures as low as 10 Torr may be used. However, if more heat transfer is desired, the compressible fluid may be pumped into the space 46 to a greater pressure. As those of skill in the art will realize, the more mass of compressible fluid that is present, the greater the heat transfer that will occur between the inner vessel 30 and the coils 48 in the space 46.

If desired, fans or other circulating devices may be added to the space 46 to increase convection within the space 46. For example, slow speed fans that circulate the compressible fluid at relatively slow speeds, e.g., 3CFM, may be helpful in some embodiments to increase convection, and thus, heat transfer. If circulating devices are used within the space 46, it is helpful to find a balance between the circulating velocity and the heat transfer needs, such that the compressible fluid does not heat too much because of the circulation.

Ultimately, the sidewall 34, the shroud 32, and the other components may be designed to reach relatively high pressures, e.g., 750 psi. The ability to pump compressible fluid into the space 46 to a wide variety of operating pressures means that a wide variety of thermal conductivities are possible.

The coolant enters the coils 48 through an input port 50, which would typically be a valved port. That valve may be electrically controllable in some embodiments. Once in the coils 48, heat is drained from the coolant through the walls of the coils 48, with the inner vessel 30 receiving the heat from the coolant and serving as a heat sink. Once the coolant has reached the desired temperature, it exits the coils 48 through an exit port 52 and is routed to the water-harvesting unit 12.

In the illustrated embodiment, the double-walled construction of the inner vessel 30 and shroud 32 is not the only means of insulation. In this embodiment, a tubular outer shell 54, a top 56, and a bottom 58 protect the inner vessel 30 and shroud 32 and provide insulation. In this embodiment, the outer shell 54, top 56, and bottom 58 are polymeric in nature; that is, they are made of common plastics. Most common polymers have relatively low thermal conductivity, and many of them also have sufficient structural rigidity to protect the inner vessel 30 and shroud 32. Depending on the application and the need for thermal insulation, these components 54, 56, 58 may have wall thicknesses in the range of about 1-3 inches or more. The components 54, 56, 58 may be molded, extruded, machined from stock materials, or cast from liquid resin components, to name a few possibilities.

In this embodiment, the outer shell 54 is made from high density polyethylene (HDPE) and the top 56 and bottom 58 are made from ultra-high molecular weight (UHMW) polyethylene. Polyethylene is an advantageous material insofar as it is widely available. For example, in some cases, the outer shell 54 may be made of a recycled HDPE pipe, rather than a custom-fabricated piece of material. Dense polymer foams may also be used in some cases. If the outer shell 54 is out-of-round, it may be circumferentially clamped to maintain its shape and prevent ballooning under stress.

Certain adaptations are made to accommodate the greater flexibility of polymeric materials. For example, wide, annular load plates 60, 62 with many bolts are used to secure the top 56 and bottom 58 in order to distribute pressures evenly and widely.

When the system 10 is operating, there are several ways in which the temperature of the coolant may be varied to an appropriate temperature. First, as was noted above, the space 46 between the inner vessel 30 and the shroud 32 has a mass of compressible fluid that can be varied in order to change the level of heat transfer. For example, an air compressor or vacuum pump in communication with the space 46 could be used to adjust the mass of compressible fluid in the space 46. In some embodiments, it may be desirable to increase the dwell time of the coolant within the coils 48 in order to effect greater or lesser heat transfer. For example, coolant could be held in the coils 48 for a few seconds, held in and let out by solenoid-actuated valves connected to the ports 50, 52. However, in order to effect continuous flow of coolant around the system 10, it may be useful to set the level of heat transfer within the space 46 such that the coolant will achieve the necessary cold temperature with continuous flow through and out of the coils 48 at some defined flow rate. For example, assuming propylene glycol as the coolant, an atmospheric temperature of 70° F. (21° C.), and a dew point of 50° F. (10° C.), if liquid nitrogen is the first cryogen in the first vessel 30 of the cryogenic cell 20, a coolant flow rate of about 0.25 gal/min (0.95 L/min) with 14.2 psi of nitrogen in the space 46 may be appropriate in at least some embodiments.

The volume of the inner vessel 30 may vary somewhat from embodiment to embodiment, but a volume sufficient to hold, e.g., 10 L of liquid nitrogen may be appropriate in most embodiments. In particularly high-volume embodiments, or in particularly difficult atmospheric conditions with very low dew points requiring very cold coolant, inner vessel 30 volumes of up to 200 L may be used.

Once installed, the cryogenic cell 20 is intended to be a self-contained, closed system and may be at least relatively low maintenance. The inner vessel 30 containing the liquid nitrogen is pressure-sealed, heat transfer across the wall of the inner vessel 30 is regulated, and the cryogenic cell 20 is insulated to prevent unwanted heat loss by the outer shell 54, top 56, and bottom 58. The cold head 40 that maintains the liquid nitrogen in liquid form is self-contained. The cold head may be a Sumitomo Cryogenics model CH-104 or model CH-110. The cryogenic compressor 40 may be, for example, a Sumitomo Cryogenics F-70 compressor. As may be apparent from the description above, cryogens do not participate directly in cooling the water-harvesting unit 12.

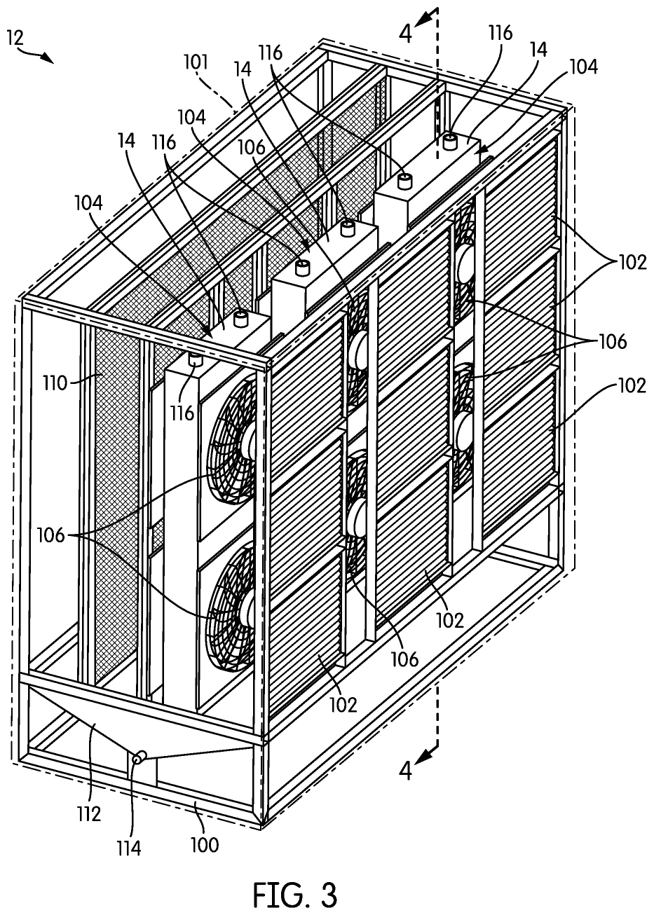

FIG. 3 is a perspective view of the water-harvesting unit 12, shown in this view without its exterior panels. The water-harvesting unit 12 is a closed cabinet or enclosure with an interior frame 100. In the view of FIG. 3, its outer panels are shown in phantom lines at 101.

With respect to the coordinate system of the figure, air enters the water-harvesting unit 12 from the right, through sets of filters 102 set into openings in the outer panels 101, such that air can essentially only enter the water-harvesting unit 12 through the filters 102. Here, the modifier “essentially only” means that the airflow path through the filters 102 is the only designed way for air to enter the water-harvesting unit 12, although it is possible that some air may be inadvertently pulled into the water-harvesting unit 12 through gaps or grooves. While the water-harvesting unit 12 is a closed enclosure, in most cases, it need not be hermetically sealed. The filters 102 themselves may be standard filters used with household or commercial ventilation systems.

The water-harvesting unit 12 may be made to various sets of dimensions depending, at least in part, on how much water is to be produced per unit period of time. In the illustrated embodiment, there are three filters 102 or sets of filters 102 set within openings in the outer panels 101, although more or fewer could be used in other embodiments.

The water-harvesting unit 12 provides two basic functions internally: an air mover draws air in, and a heat exchanger is used to expose that air to cold coolant so that water condenses out of the air. In the illustrated embodiment, the air-moving and heat-exchange functions are combined into single units. Specifically, three combined fan/heat exchange units 104 sit behind the filters 102 to draw in and receive filtered air. Each of these combined fan/heat exchange units 104 has a fan 106 and the heat exchanger 14.

In contrast to the closed system of the cryogenic cell 20, the water-harvesting unit 12 is expected to require maintenance in the field. Thus, it is helpful if the parts within the water-harvesting unit 12 are readily removed and replaced. Modular, combined fan/heat exchange units 104 may be easier to remove and replace in case of wear or malfunction and, generally speaking, require less wiring and installation labor. In one embodiment, these modular, combined fan/heat exchange units 104 may be commercial, off-the-shelf parts. For example, the combined fan/heat exchange units may be oil cooling units designed for automotive racing, such as the CBR0059 oil cooler (CBR Performance Products, Inc., Lake Elsinore, Calif., United States). These units have overall dimensions of 32 in×14 in×8.5 in (0.81 m×0.36 m×0.23 m) with two 12-inch (0.30 m) fans 106. In addition to using off-the-shelf components whenever possible, the frame 100 of the water-harvesting unit 12 provides a good deal of space between internal components, potentially making those components easier to service.

In use, water may condense directly on the heat exchanger 14. However, the water-harvesting unit 12 also provides screens 110 after the heat exchanger 14 on which water can condense. The screens 110 may be made of a mesh, like a FIBERGLAS® glass-fiber mesh. Once water has condensed on the heat exchanger 14 or on the screens 110, it may drip off under the influence of gravity. A trough 112 is provided below the filters 102, combined fan/heat exchange units 104, and screens 110. The trough 112 is angled inward and downward and extends across the entire width of the water-harvesting unit 12. The trough 112 is also canted or angled toward a water outlet 114 on one side of the water-harvesting unit 12, so that all water collected flows toward the water outlet 114. The water outlet 114 may be a simple pipe or spigot, or it may feature a faucet or other, similar structure.

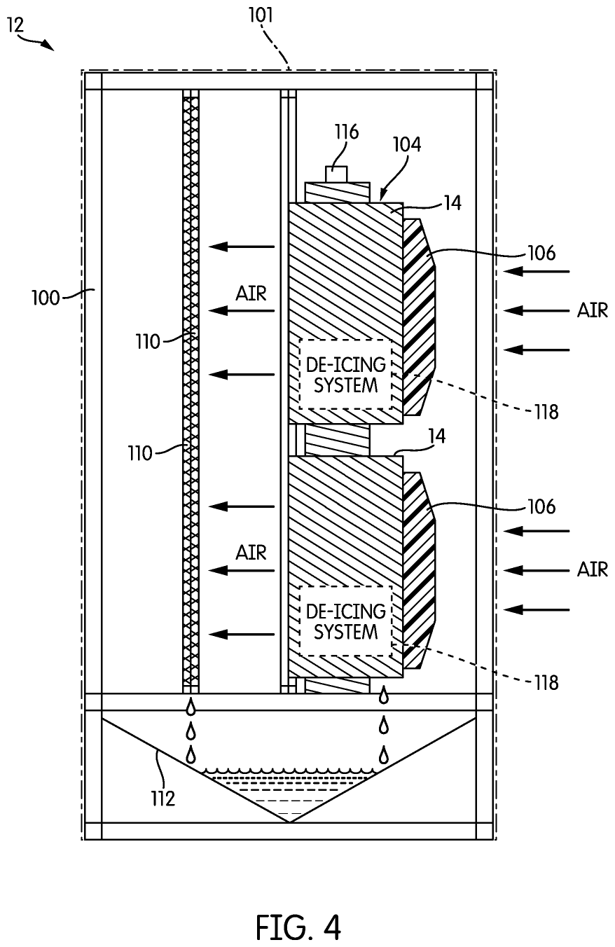

FIG. 4 is a schematic cross-section of the water-harvesting unit 12, taken through Line 4-4 of FIG. 3. Coolant itself enters and exits each heat exchanger 14 through inlet and outlet ports 116 which, in the illustrated embodiment, lie along the upper surface of each heat exchanger 14. In the coordinate system of FIG. 4, air enters the water-harvesting unit 12 from the right, drawn in by the fans 106. As the moisture-laden air comes in contact with the heat exchanger 14, some water may condense on the heat exchanger 14 itself. If so, the trough 112 is positioned to catch it. More water, cooled by the heat exchanger 14, may condense on the screens 110 and fall into the trough 112.

FIG. 4 illustrates an additional feature of the water-harvesting unit 12. In some circumstances, the dew point may be below the freezing point of water. This means that when water condenses out of the air, it may also freeze, on either the heat exchanger 14 or on the screens 110. For this reason, the water-harvesting unit 12 may have a de-icing system 118 or a number of de-icing systems 118 on the heat exchangers 14, the screens 110, or both. These de-icing systems 118 may comprise, for example, so-called “hot wire” resistance heating systems, similar to defrosting systems on automobile windows. The de-icing systems 118 may be used to melt any ice that forms or, at least, dislodge it from the heat exchangers 14 and screens 110 enough to prevent obstruction to air flow and further condensation of water.

The advantage of system 10 of FIGS. 1-4 is that, because the cryogenic cell 20 can cool to very cold temperatures, whatever the ambient dew point, the coolant can be cooled to a temperature appropriate to cause water to condense. This means that, if necessary, system 10 can operate in conditions in which other water-harvesting systems may not be able to operate.’

Water that is condensed with system 10 may be further processed, for purification purposes. In some cases, it may be pumped or otherwise transferred from the water outlet 114 to a storage tank or cistern. Water may be purified chemically, by exposure to energy such as UV light, or in any other suitable manner.

FIGS. 1-4 illustrate an embodiment of system 10 with no particular control elements. In system 10, the components may simply be switched on when it is time to make water and switched off when enough water is made. This is certainly the simplest arrangement. However, more sophisticated arrangements may be helpful in other embodiments.

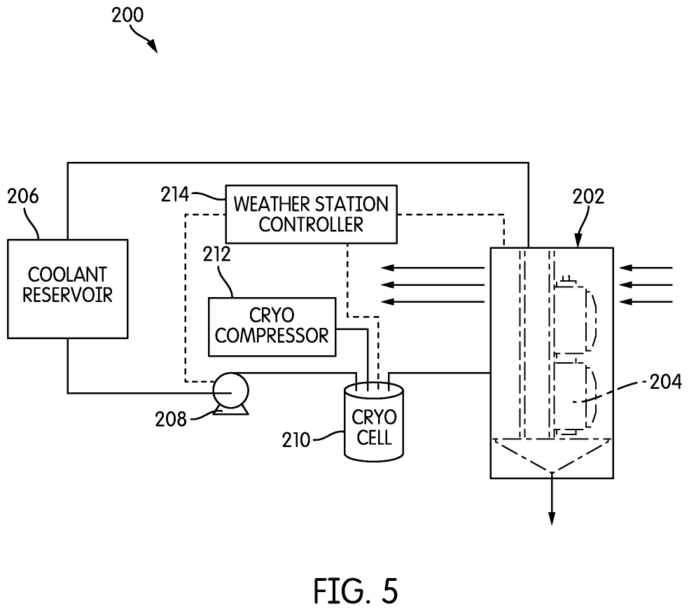

FIG. 5 is a schematic illustration of a system, generally indicated at 200, according to another embodiment of the invention. System 200 has familiar components: a water-harvesting unit 202 with a combined fan/heat exchange unit 204 that is fed by a circuit including a coolant reservoir 206, a pump 208, and a cryogenic cell 210. The cryogenic cell 210 has its own cryogenic compressor 212. These components are all essentially as described above. System 200 differs from system 10 in that it also includes a weather station/controller 214.

Although an atmospheric water harvesting system 10, 200 according to embodiments of the invention can operate in essentially any ambient conditions, there may be conditions under which it is more advantageous or less energy-intensive to operate. The presence of a weather station/controller 214 may make it easier to tailor operations to those conditions. For example, the controller 214 may include a clock, and may trigger the operation of system 200 only at night. It may include a dew point sensor and trigger the operation of system 200 only when the dew point is above a defined temperature, such as the freezing point of water. It may also control the pump 208, the cryogenic cell 210, and the water-harvesting unit 202 to achieve the proper coolant temperature for a particular dew point. For example, the controller 214 may increase or decrease coolant flow rates by controlling the pump 208, or the controller 214 may control valves leading to and from the cryogenic cell 210 to cause the coolant to dwell for some time within the coils 48 of the cryogenic cell 210. In some cases, a controller 214 may activate a valve or a vacuum pump to control the amount of mass in the heat-transfer space 46, so as to increase or decrease heat transfer. The controller 214 may also be responsible for switching a de-icing system 118 on and off, and for establishing basic error conditions, providing diagnostic data, and shutting system 200 down when needed.

In the embodiments of FIGS. 1-5, the coolant goes directly from a cryogenic cell 20, 210 into the heat exchanger 14, 204. The advantage of this is that the coolant is presumably at or near its lowest temperature when it enters the heat exchanger 14, 204, meaning that it can absorb more heat from the incoming air and cause more water to condense. However, when one is using a cryogenic cell 20, 210 to cool the coolant, despite the moderation of heat transfer that the cryogenic cell 20, 210 allows, there are situations in which the coolant may emerge from the cryogenic cell 20, 210 much colder than required. As described above, it is perfectly possible to adjust the cryogenic cell 20, 210 to moderate the heat transfer, but as was also described above, it may be simpler to set the cryogenic cell 20, 210 once and operate it as a closed system without further adjustment. In that case, there are other ways to adjust the temperature of cold coolant.

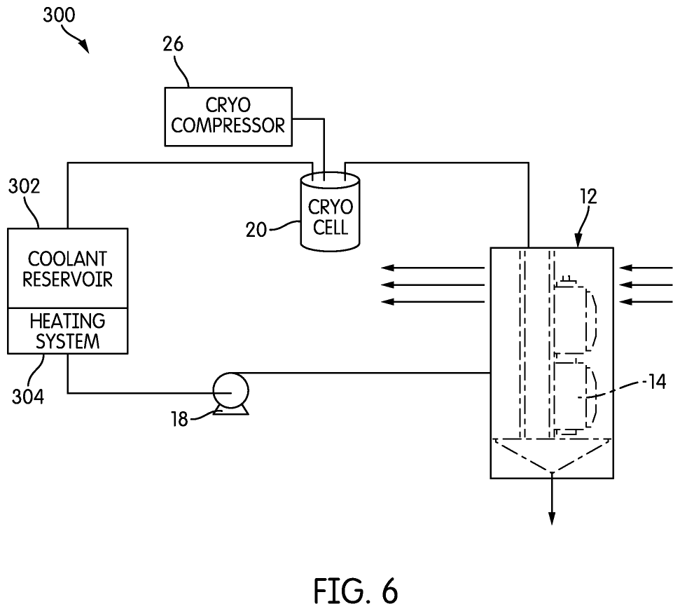

FIG. 6 is a schematic view of an atmospheric water harvesting system, generally indicated at 300, according to another embodiment of the invention. The components of the atmospheric water harvesting system 300 are generally the same as their counterparts in the system 10 of FIG. 1; therefore, those components not described here may be assumed to be the same as the components described above.

In the atmospheric water harvesting system 300 of FIG. 6, the cryogenic cell 20 is located on the return side of system 300, between the outlet of the heat exchanger 14 and the reservoir 302. In other words, instead of being pumped cold directly from the cryogenic cell 20 into the heat exchanger 14, the coolant is pumped cold from the reservoir 302 into the heat exchanger 14 and enters the cryogenic cell 20 only after it has absorbed heat from the incoming air.

In system 300, between the cryogenic cell 20 and the coolant's return to the heat exchanger 14, there is a heating system 304 that can be used to adjust the temperature of the coolant, as needed. In this case, the heating system 304 is located in the reservoir 302, although it could be located elsewhere. The heating system 304 may take various forms. A wire-resistance heating element or elements within the reservoir 302 may be the most common type of heating system 304, although other types of heating systems, including Pelletier-effect heaters, heat pumps, boilers, and solar heaters may also be used.

With this arrangement, cold coolant entering the reservoir 302 can be heated as needed to place it at the appropriate temperature before being pumped into the heat exchanger 14. This allows system 300 to correct for the problem of “cold overshoot” without having to adjust the cryogenic cell 20. If no reservoir 302 is used, the heating system 304 may be installed elsewhere, e.g., along a segment of piping between the cryogenic cell 20 and the heat exchanger 14. System 300 of FIG. 6 is shown without a controller 214 for simplicity in illustration, but a controller 214 could be added, much as shown in FIG. 5, in which case it could additionally control the heating system 304 in accordance with measured ambient conditions and a measured temperature of the coolant.

With the arrangement of system 300, heat transfer between the coolant and the environment from the time that it leaves the cryogenic cell 20 cold to the time that it enters the heat exchanger 14 may be more of a concern. As with any other embodiment of an atmospheric water harvesting system 10, 200, 300, piping and the reservoir 302 may be insulated to prevent or retard heat transfer. Of course, in some cases, a limited amount of heat transfer between the coolant and the environment may be allowed through the piping, e.g., to warm the coolant slightly for the same reasons as described above.

Portions of this description use the term “about.” As used here, that term means that the stated value or range of values may change, so long as the described result or benefit does not change. If it cannot be determined what value or range of values would cause the described result to change, then “about” should be interpreted to mean±5%.

While the invention has been described with respect to certain embodiments, the description is intended to be exemplary, rather than limiting. Modifications and changes may be made within the scope of the invention, which is determined by the appended claims.

What is claimed is:

1. An atmospheric water harvester, comprising:
a water-harvesting unit including a heat exchanger and an air mover positioned and adapted to draw air to the heat exchanger;
a coolant pathway including a non-cryogenic fluid coolant, the coolant pathway in fluid communication with the heat exchanger to supply the coolant to the heat exchanger; and
a cryogenic cell in the coolant pathway, the cryogenic cell adapted to receive the fluid coolant and to remove heat from the fluid coolant by causing or allowing a controlled heat transfer between the fluid coolant and a first cryogen sealed within an inner vessel in the cryogenic cell.

2. The atmospheric water harvester of claim 1, wherein the non-cryogenic fluid coolant comprises a liquid coolant.

3. The atmospheric water harvester of claim 2, wherein the controlled heat transfer occurs without changing a phase of the liquid coolant.

4. The atmospheric water harvester of claim 3, wherein the water-harvesting unit further comprises one or more perforated water-condensing screens.

5. The atmospheric water harvester of claim 4, wherein the water-harvesting unit further comprises a trough positioned to catch water condensed on the heat exchanger and the water-condensing screens.

6. The atmospheric water harvester of claim 5, further comprising an outlet in fluid communication with an interior of the trough.

7. The atmospheric water harvester of claim 3, further comprising a coolant reservoir in the coolant pathway.

8. The atmospheric water harvester of claim 3, further comprising a coolant pump in the coolant pathway.

9. The atmospheric water harvester of claim 1, wherein the cryogenic cell includes
the vessel,
an outer shroud, and
a set of tubes or coils in a space defined between the vessel and the shroud;
wherein the space defined between the vessel and the shroud is at least partially evacuated so as to provide the controlled heat transfer.

10. The atmospheric water harvester of claim 9, wherein the set of tubes or coils do not make physical contact with the vessel.

11. The atmospheric water harvester of claim 1, wherein the cryogenic cell is arranged in the coolant pathway between an outlet of the heat exchanger and a reservoir.

12. The atmospheric water harvester of claim 11, wherein the reservoir includes a heating system.

13. An atmospheric water harvester, comprising:
a water-harvesting unit including
a heat exchanger,
an air mover positioned and adapted to draw air to the heat exchanger,
one or more condensation screens spaced from the heat exchanger, and
a trough positioned to catch water condensed on the heat exchanger and the screens;
a coolant pathway including a non-cryogenic fluid coolant, the coolant pathway in fluid communication with the heat exchanger to supply the coolant to the heat exchanger; and
a cryogenic cell in the coolant pathway, the cryogenic cell adapted to receive the fluid coolant and to remove heat from the fluid coolant by causing or allowing a controlled heat transfer between the fluid coolant and a first cryogen sealed within an inner vessel within the cryogenic cell.

14. The atmospheric water harvester of claim 13, wherein the non-cryogenic fluid coolant comprises a liquid coolant.

15. The atmospheric water harvester of claim 14, wherein the controlled heat transfer occurs without changing a phase of the liquid coolant.

16. The atmospheric water harvester of claim 15, wherein the heat exchanger and the air mover are combined into one or more combined units.

17. The atmospheric water harvester of claim 15, wherein one or both of the heat exchanger and the one or more condensation screens include a de-icing system.

18. The atmospheric water harvester of claim 17, wherein the de-icing system comprises a resistive heating system.

19. The atmospheric water harvester of claim 15, further comprising a controller.

20. The atmospheric water harvester of claim 19, wherein the controller includes a weather station.

21. The atmospheric water harvester of claim 13, wherein the cryogenic cell includes
the vessel,
an outer shroud, and
a set of tubes or coils in a space defined between the vessel and the shroud;
wherein the space defined between the vessel and the shroud is at least partially evacuated so as to provide the controlled heat transfer.

22. The atmospheric water harvester of claim 21, wherein the set of tubes or coils do not make physical contact with the vessel.

23. The atmospheric water harvester of claim 13, wherein the cryogenic cell is arranged in the coolant pathway between an outlet of the heat exchanger and a reservoir.

24. The atmospheric water harvester of claim 23, wherein the reservoir includes a heating system.
